(19) United States
(12) Patent Application Publication
(10) Pub. No.: US 2019/0132514 A1
(43) Pub. Date: May 2, 2019

(54) IMAGE CAPTURING APPARATUS, SUPPORTING APPARATUS, AND CONTROL METHODS THEREFOR

(71) Applicant: CANON KABUSHIKI KAISHA, Tokyo (JP)

(72) Inventors: Toshio Ibi, Kawasaki-shi (JP); Toshihide Kanayama, Kawasaki-shi (JP)

(21) Appl. No.: 16/170,217

(22) Filed: Oct. 25, 2018

(30) Foreign Application Priority Data
Oct. 31, 2017 (JP) 2017-211207

(51) Int. Cl. H04N 5/232

(52) U.S. Cl. CPC H04N 5/23258; H04N 5/23299; H04N 5/23267; H04N 5/2328

(57) ABSTRACT

An image capturing apparatus having a movable unit for performing image capture and a supporting unit that supports the movable unit, the movable unit including an image capturing unit that captures an object, and the supporting including a driving unit that drives so as to change the orientation of the movable unit, a position detection unit that detects the position of the movable unit, a shake detection unit that detects shake of the image capturing apparatus, a determination unit that determines a driving target position of the driving unit, based on the shake detected by the shake detection unit, and a control unit that controls the driving unit such that the position of the movable unit detected by the position detection unit converges to the driving target position determined by the determination unit.

### BACKGROUND OF THE INVENTION

### Field of the Invention

The present invention relates to an image capturing apparatus having an image blur correction function.

### Description of the Related Art

In recent years, many panhead image capturing apparatuses have been commercialized that, by operating an actuator such as a motor, are capable of changing the direction of a camera omnidirectionally, including pan and tilt operations. With these panhead image capturing apparatuses, it is becoming increasingly important to increase the rotation speed and be able quickly direct the camera toward an object, so as to be able to sequentially track a plurality of objects.

In such a panhead image capturing apparatus, a gimbal structure is often used, in order to continuously track a target omnidirectionally. On the other hand, as a structure for orienting a camera omnidirectionally, without using rotation axes such as a gimbal structure, a structure has been proposed that rotationally drives a sphere incorporating a camera, which is a movable unit, through friction using a piezoelectric element.

Also, optical image blur correction is used as a method of correcting image blur caused by shake such as camera shake transferred to an image capturing apparatus such as a still camera or a video camera. In optical image blur correction, shake is detected from an image formed on the image sensor, a target position of the shift lens is calculated based on the detected amount of shake, and the shift lens is moved to the target position in a direction perpendicular to the optic axis. At this time, feedback control for reducing deviation between the target position and the actual position to zero is performed, for example. Electronic image blur correction that shifts the image capturing area by comparing a captured image with subsequently captured images and computing the amount of movement is also used.

The above image blur correction control is also applied to panhead image capturing apparatuses. Specifically, image blur of a panhead image capturing apparatus is corrected, by detecting vibration that is applied to the panhead image capturing apparatus and panning or tilting the orientation of the camera based on the detected amount of shake, and by also applying electronic image blur correction.

The relevant technologies are disclosed in Japanese Patent No. 5383926 and Japanese Patent Laid-Open No. 2014-175774.

Conventionally, a driven body-side electronic circuit of a camera that has a lens optical system and an image sensor and a drive-side electronic circuit of a base that has a central processing unit for controlling the entirety of the image capturing apparatus and supports the camera are connected by cable or the like. At this time, the electronic circuit on the base side and the electronic circuit on the camera side are configured to move in an integrated manner electrically.

However, in the case where the camera and the base are connected by cable or the like, there is a problem in that the movable range of the camera, which is the driven body, relative to the base is restricted by the electrical wiring. In view of this, in order to eliminate restrictions on the movable range due to the wired connection, it is conceivable to perform data transmission wirelessly between the camera and the base. However, when shake detection data of a panhead image capturing apparatus is transmitted between the camera and the base by wireless data communication, a problem arises in that image blur correction cannot be performed at an appropriate timing owing to transmission delay.

### SUMMARY OF THE INVENTION

The present invention was made in consideration of the abovementioned problems, and provides an image capturing apparatus that is able to suppress a drop in the performance of image blur correction, even in the case where data transmission between a camera and a base is performed wirelessly.

According to a first aspect of the present invention, there is provided an image capturing apparatus comprising: a movable unit configured to perform image capture; and a supporting unit configured to support the movable unit, wherein the movable unit includes: an image capturing unit configured to capture an object, and the supporting unit includes: a driving unit configured to drive so as to change an orientation of the movable unit; a position detection unit configured to detect a position of the movable unit; a shake detection unit configured to detect shake of the image capturing apparatus; a determination unit configured to determine a driving target position of the driving unit, based on the shake detected by the shake detection unit; and a control unit configured to control the driving unit such that the position of the movable unit detected by the position detection unit converges to the driving target position determined by the determination unit.

According to a second aspect of the present invention, there is provided a supporting apparatus that supports a movable unit including an image capturing unit configured to capture an object, comprising: a driving unit configured to drive so as to change an orientation of the movable unit; a position detection unit configured to detect a position of the movable unit; a shake detection unit configured to detect shake of the supporting apparatus; a determination unit configured to determine a driving target position of the driving unit, based on the shake detected by the shake detection unit; and a control unit configured to control the driving unit such that the position of the movable unit detected by the position detection unit converges to the driving target position determined by the determination unit.

According to a third aspect of the present invention, there is provided a control method for an image capturing apparatus including a movable unit having an image capturing unit configured to capture an object and a supporting unit configured to support the movable unit, the method comprising: driving so as to change an orientation of the movable unit; detecting a position of the movable unit; detecting shake of the image capturing apparatus; determining a driving target position in the driving, based on the shake detected in the shake detection; and controlling the driving such that the position of the movable unit detected in the position detection converges to the driving target position determined in the determination.

According to a fourth aspect of the present invention, there is provided a control method for a supporting apparatus configured to support a movable unit including an image capturing unit configured to capture an object, the control method comprising: driving so as to change an orientation of the movable unit; detecting a position of the movable unit; detecting shake of the image capturing apparatus; determining a driving target position in the driving, based on the shake detected in the shake detection; and controlling the driving such that the position of the movable unit detected in the position detection converges to the driving target position determined in the determination.

Further features of the present invention will become apparent from the following description of exemplary embodiments with reference to the attached drawings.

### BRIEF DESCRIPTION OF THE DRAWINGS

FIG. 1 is a block diagram of an image capturing apparatus according to a first embodiment of the present invention.

FIG. 2A is an external perspective view of the image capturing apparatus of the first embodiment.

FIG. 2B is an external perspective view of the image capturing apparatus of the first embodiment.

FIG. 3 is a block diagram showing a configuration for correcting image blur.

FIG. 4 is a block diagram showing a configuration for electronically correcting image blur.

FIG. 5 is a flowchart showing image capturing operations in the first embodiment.

FIG. 6A is an external perspective view of an image capturing apparatus of a second embodiment.

FIG. 6B is a plan view of the image capturing apparatus of the second embodiment.

FIGS. 7A and 7B are diagrams showing a coordinate system in the second embodiment.

FIG. 8 is a block diagram showing a configuration for correcting image blur in the second embodiment.

FIG. 9 is a flowchart showing image capturing operations in the second embodiment.

FIG. 10 is a block diagram of an image capturing apparatus according to a third embodiment.

FIG. 11 is a block diagram showing a configuration for electronically correcting image blur in the third embodiment.

FIG. 12 is a flowchart showing image capturing operations in the third embodiment.

FIG. 13 is a diagram showing synchronization of image capture data and shake signals in the third embodiment.

### DESCRIPTION OF THE EMBODIMENTS

Hereinafter, embodiments of the present invention will be described in detail with reference to the accompanying drawings.

### First Embodiment

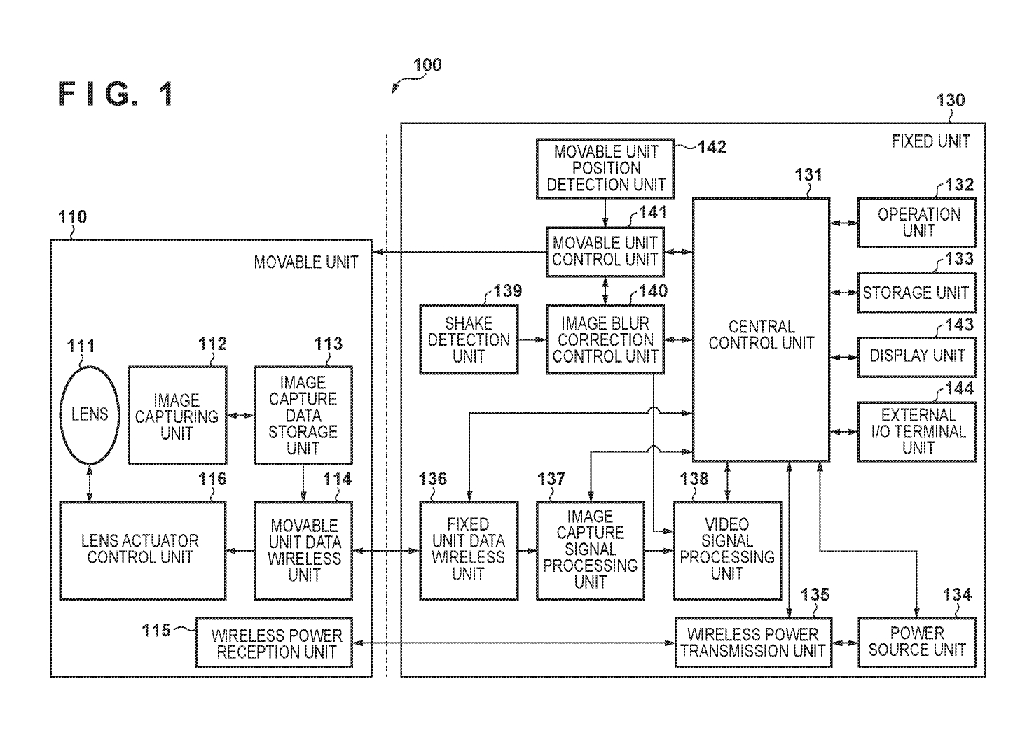

FIG. 1 is a block diagram showing the configuration of an image capturing apparatus according to a first embodiment of the present invention. In FIG. 1, an image capturing apparatus 100 is configured to include a movable unit 110 including a lens unit and a fixed unit 130 including a central control unit (CPU) that performs drive control of the movable unit 110 and control of the entirety of the image capturing apparatus.

First, the configuration of the movable unit 110 will be described. A lens unit (image capturing optical system) 111 is configured to include a zoom unit, a diaphragm/shutter unit and a focusing unit, and forms an object image on an image capturing unit 112. The image capturing unit 112 includes an image sensor consisting of a CMOS sensor, a CCD sensor or the like, and performs photoelectric conversion of the optical image formed of the lens unit 111 and outputs an electrical signal. An image capture data storage unit 113 stores output data of the image capturing unit 112, and transmits stored image capture data to a movable unit data wireless unit 114. The movable unit data wireless unit 114 includes a transmitting and receiving antenna, and implements wireless communication of data between the movable unit 110 and the fixed unit 130. Here, when transmitting output data from the image capturing unit 112 to the fixed unit 130 by wireless communication, the output data is transmitted in chronological order of the image capture data stored in the image capture data storage unit 113.

A lens actuator control unit 116 includes a motor driver IC, and drives the various actuators of the lens unit 111 including the zoom unit, the diaphragm/shutter unit and the focusing unit. The various actuators are driven based on actuator drive instruction data of the lens unit 111 received by the movable unit data wireless unit 114. A wireless power reception unit 115 receives power wirelessly from the fixed unit 130, and supplies received power to the entirety (each element) of the movable unit 110 according to the application.

Next, the configuration of the fixed unit (supporting unit) 130 will be described. A central control unit 131 consists of a CPU, and controls the entirety of the image capturing apparatus 100. A fixed unit data wireless unit 136 implements reception of image capture data obtained by the image capturing unit 112 of the movable unit 110 and transmission of drive instruction signals for the various actuators of the lens unit 111, between the movable unit 110 and the fixed unit 130, through wireless communication.

A shake detection unit 139 detects shake (vibration) that is applied to the image capturing apparatus 100, and an image blur correction control unit 140 calculates the drive amount of the movable unit required in order to correct image blur caused by shake of the image capturing apparatus 100, based on a shake signal output by the shake detection unit 139. A movable unit position detection unit 142 detects pan and tilt positions of the movable unit 110. A movable unit control unit 141 includes a driving unit that rotationally drives the movable unit 110 to pan and tilt positions, and drives the movable unit 110 such that the pan and tilt positions of the movable unit 110 output by the movable unit position detection unit 142 move to desired positions. An operation unit 132 is provided in order to operate the image capturing apparatus 100, and, in the case where an instruction for turning on an image blur correction function is input from the operation unit 132, the image blur correction control unit 140 instructs the movable unit control unit 141 to perform an image blur correction operation.

An image capture signal processing unit 137 converts the electrical signal of the image capturing unit 112 output by the fixed unit data wireless unit 136 into a video signal. A video signal processing unit 138 processes the video signal output by the image capture signal processing unit 137 according to the application. Processing of the video signal also includes an electronic image blur correction operation by image segmentation and rotation processing.

A power source unit 134 supplies power to the entirety (each element) of the image capturing apparatus according to the application. A wireless power transmission unit 135 transmits power wirelessly to the movable unit 110. A storage unit 133 stores various data such as video information and the like obtained by image capture. A display unit 143 is provided with a display such as an LCD, and performs image display when needed, based on the signal output by the video signal processing unit 138. An external I/O terminal unit 144 inputs and outputs transmission signals and video signals from and to external apparatuses.

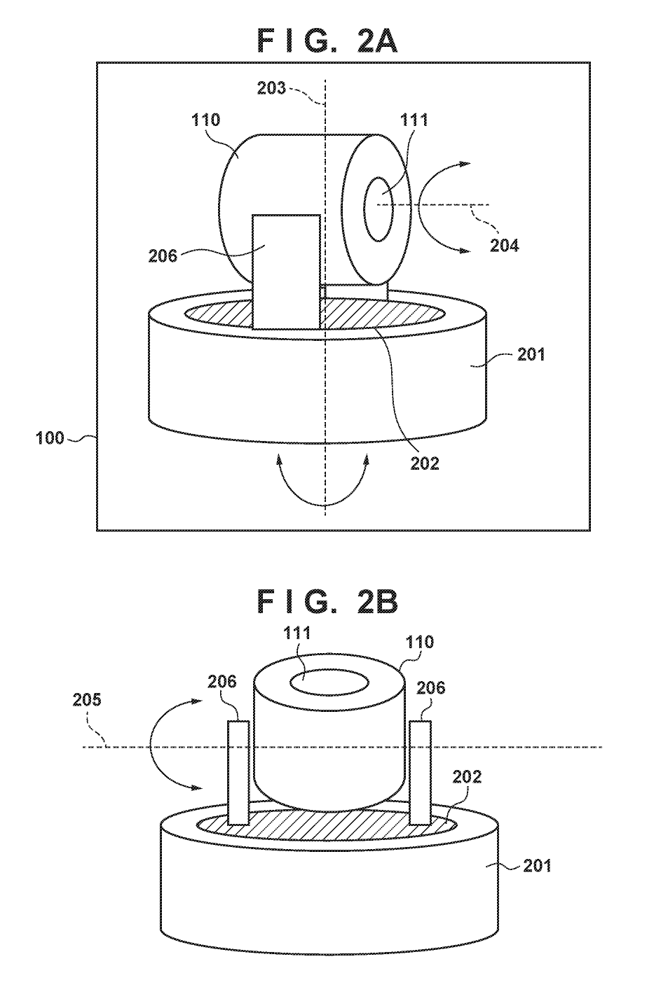

Next, pan and tilt mechanisms of the image capturing apparatus 100 for changing the image capturing direction will be described. FIG. 2A and FIG. 2B are diagrams illustrating the pan and tilt mechanisms of the image capturing apparatus 100.

FIG. 2A is a side view of the image capturing apparatus 100, with a rotation unit of the pan mechanism being constituted by a bottom case 201 and a turntable 202, and the turntable 202 rotating about a pan rotation axis 203. Also, rotation about a lens optical axis 204 of the movable unit 110 is called roll direction rotation.

FIG. 2B is a front view of the image capturing apparatus 100. In FIG. 2B, a rotation unit of the tilt mechanism is constituted by a lens support 206, and the movable unit 110 rotates about a tilt rotation axis 205. The fixed unit 130 is disposed inside the bottom case 201, and does not move even when the pan and tilt mechanisms operate. In contrast, the lens support 206 is fixed to the turntable 202, and turns together with the rotation operation of the pan mechanism. Also, the lens support 206 includes a drive actuator for tilt rotation and a tilt angle position detection element, and is electrically connected to the fixed unit 130. For example, a slip ring configuration using a connecting cable or a brush contact is used as the electrical connection method.

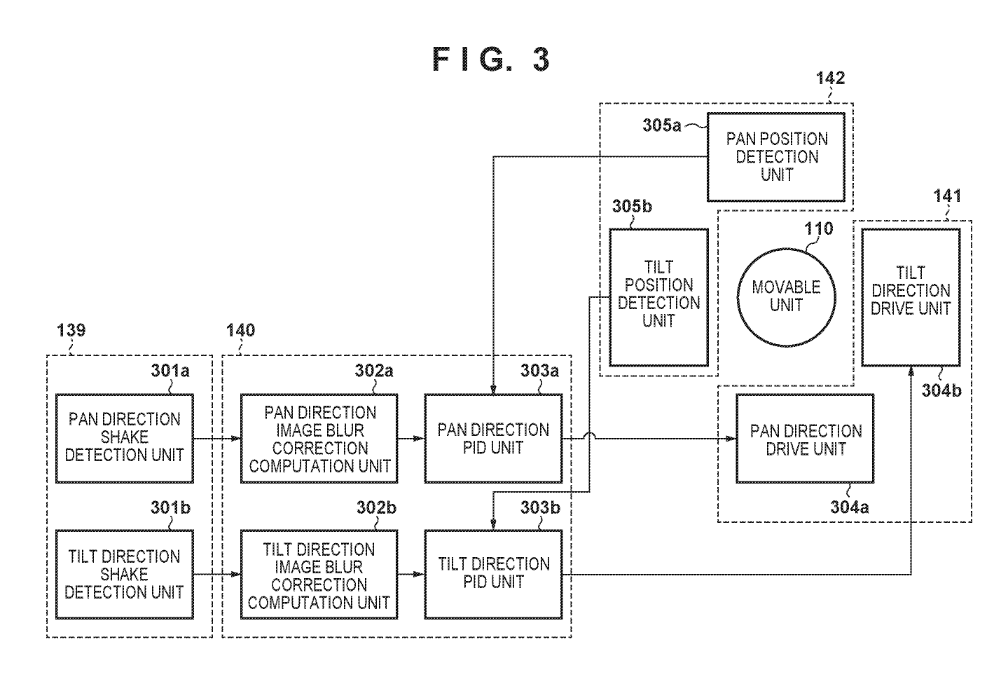

Next, a method of correcting image blur due to shake of the image capturing apparatus 100 will be described, with reference to FIG. 3. FIG. 3 is a block diagram showing the configuration of the shake detection unit 139, the image blur correction control unit 140, the movable unit control unit 141 and the movable unit position detection unit 142.

The shake detection unit 139 is provided with a pan direction shake detection unit 301a that detects shake (vibration) in the pan direction that is applied to the image capturing apparatus 100, and a tilt direction shake detection unit 301b that detects shake in the tilt direction. The pan direction shake detection unit 301a and the tilt direction shake detection unit 301b are constituted to include an angular velocity sensor or a velocity sensor, for example. The pan direction shake detection unit 301a detects shake in the horizontal direction (pan direction) of the image capturing apparatus 100 in a normal attitude (attitude in which the longitudinal direction of an image frame substantially coincides with the horizontal direction), and outputs a shake signal. The tilt direction shake detection unit 301b detects shake in the vertical direction (tilt direction) of the image capturing apparatus 100 in a normal attitude, and outputs a shake signal.

The image blur correction control unit 140 is constituted to include a pan direction image blur correction computation unit 302a, a pan direction PID unit 303a, a tilt direction image blur correction computation unit 302b and a tilt direction PID unit 303b. The pan direction image blur correction computation unit 302a calculates a control signal of the movable unit 110 in the pan direction, based on the shake signal output by the pan direction shake detection unit 301a. Similarly, the tilt direction image blur correction computation unit 302b calculates a control signal of the movable unit 110 in the tilt direction, based on the shake signal output by the tilt direction shake detection unit 301b.

The movable unit position detection unit 142 is provided with a pan position detection unit 305a and a tilt position detection unit 305b, and these detection units are respectively installed in correspondence with the pan rotation axis 203 and the tilt rotation axis 205. The pan position detection unit 305a detects the angle of rotation of the turntable 202 relative to the bottom case 201. The tilt position detection unit 305b detects the angle of rotation of the movable unit 110 relative to the lens support 206.

The pan direction PID unit 303a and the tilt direction PID unit 303b each have a proportional control unit that performs proportional control, an integral control unit that performs integral control, and a derivative control unit that performs derivative control. As a result of such a configuration, the pan direction PID unit 303a calculates a control amount based on the deviation between a control signal of the movable unit 110 output by the pan direction image blur correction computation unit 302a and a position signal output by the pan position detection unit 305a, and outputs a drive command signal. The tilt direction PID unit 303b also similarly calculates a control amount based on the deviation between a control signal of the movable unit 110 output by the tilt direction image blur correction computation unit 302b and a position signal output by the tilt position detection unit 305b, and outputs a drive command signal.

The movable unit control unit 141 is constituted to include a pan direction drive unit 304a and a tilt direction drive unit 304b. The pan direction drive unit 304a and the tilt direction drive unit 304b each have an actuator (or motor). The pan direction drive unit 304a and the tilt direction drive unit 304b drive the orientation of the movable unit 110 in the pan and tilt directions, based on the drive command signal (drive control signal) output by the pan direction PID unit 303a and the tilt direction PID unit 303b.

In this way, the pan direction PID unit 303a performs feedback control, such that the position signal that is output by the pan position detection unit 305a converges to the control signal of the movable unit 110 that is output by the pan direction image blur correction computation unit 302a. The tilt direction PID unit 303b also similarly performs feedback control, such that the position signal output by the tilt position detection unit 305b converges to the control signal of the movable unit 110 that is output by the tilt direction image blur correction computation unit 302b.

The control signal of the movable unit in the pan direction that is calculated by the pan direction image blur correction computation unit 302a based on the shake signal output by the pan direction shake detection unit 301a is a signal representing the driving target position (shake correction position) in the pan direction. Similarly, the control signal of the movable unit in the tilt direction that is calculated by the tilt direction image blur correction computation unit 302b based on the shake signal output by the tilt direction shake detection unit 301b is a signal representing the driving target position (shake correction position) in the tilt direction. The movable unit 110 is thus moved in a direction that corrects image blur due to shake of the image capturing apparatus 100, based on the control signals of the movable unit that are output by the pan direction image blur correction computation unit 302a and the tilt direction image blur correction computation unit 302b. In this way, image blur can be reduced, even in the case where vibration such as camera shake occurs in the image capturing apparatus 100, as a result of the direction of the movable unit 110 moving in directions (pan direction and tilt direction) orthogonal to the optical axis.

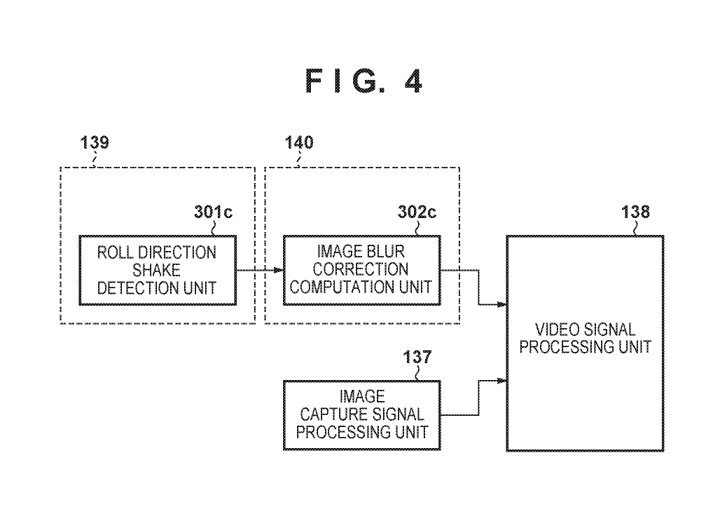

Next, a method of electronically correcting image blur due to shake of the image capturing apparatus 100 will be described, with reference to FIG. 4. FIG. 4 is a block diagram showing the configuration of the shake detection unit 139, the image blur correction control unit 140, the image capture signal processing unit 137 and the video signal processing unit 138.

The shake detection unit 139 is provided with a roll direction shake detection unit 301c that detects shake (vibration) in the roll direction that is applied to the image capturing apparatus 100. The roll direction shake detection unit 301c is constituted to include an angular velocity sensor or a velocity sensor, for example. The roll direction shake detection unit 301c detects shake in the rotation direction (roll direction) around the optical axis of the image capturing apparatus 100 in a normal attitude (attitude in which the longitudinal direction of an image frame substantially coincides with the horizontal direction), and outputs a shake signal.

The image blur correction control unit 140 is constituted to include a roll direction image blur correction computation unit 302c. The roll direction image blur correction computation unit 302c, based on the shake signal output by the roll direction shake detection unit 301c, calculates the angle of rotation in the roll direction, and calculates a control signal for rotation in the roll direction.

The image capture signal processing unit 137 converts the electrical signal of the image capturing unit 112 output by the fixed unit data wireless unit 136 into a video signal. In the video signal processing unit 138, segmentation and rotation processing is performed on the video signal output by the image capture signal processing unit 137, based on the control signal for rotation in the roll direction calculated by the roll direction image blur correction computation unit 302c. Electronic correction is thereby performed so as to correct the sloping of video resulting from rotation in the roll direction. In this way, image blur can be reduced, even in the case where vibration such as camera shake that rotates in a direction around the optical axis of the movable unit 110 (roll direction) occurs in the image capturing apparatus 100.

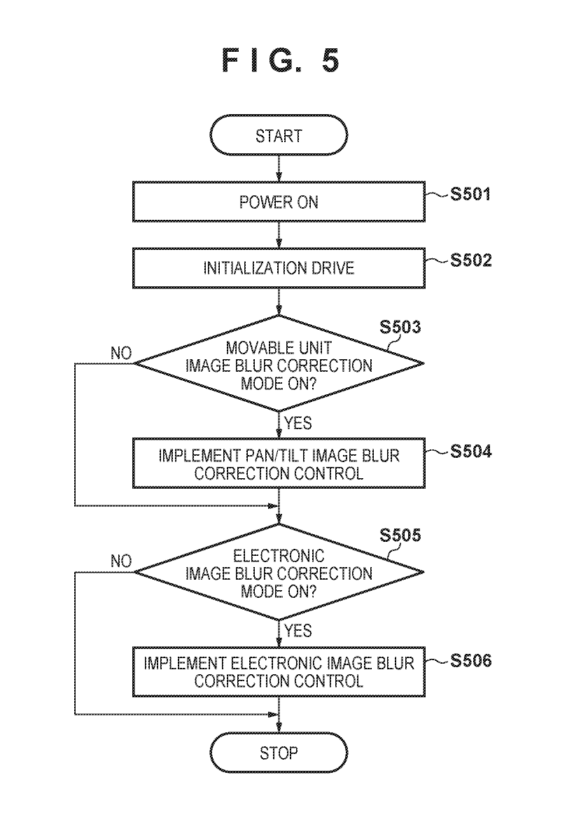

Next, image capturing operations including the image blur correction operation of the present embodiment will be described, with reference to FIG. 5. FIG. 5 is a flowchart showing image capturing operations. The steps of FIG. 5 are mainly executed based on commands from the central control unit 131 of the image capturing apparatus 100.

First, when the image capturing apparatus 100 is powered on by the user in step S501, the central control unit 131, in step S502, performs control such that the movable unit control unit 141 performs an initialization operation for fixing the movable unit 110 at predetermined pan and tilt positions.

Next, in step S503, the central control unit 131 determines whether a movable unit image blur correction mode (movable unit image blur correction function) is turned on. If the central control unit 131 determines that the movable unit image blur correction mode is turned on, the processing advances to step S504. In step S504, the central control unit 131 performs control such that the image blur correction control unit 140 performs an image blur correction operation for calculating the amplitude of the shake (vibration) of the image capturing apparatus 100, and driving the movable unit 110 in the pan direction and the tilt direction according to the calculated amplitude. Here, the image blur correction operation is performed by interrupt processing that occurs in a regular cycle (e.g., every 250 μsec). Also, in the present embodiment, image blur correction control in each of the pan direction (traverse direction) and the tilt direction (longitudinal direction) is performed.

On the other hand, if, in step S503, the central control unit 131 determines that the movable unit image blur correction mode is turned off, the central control unit 131 performs control to maintain the state in which the movable unit 110 is fixed at the initialization operation position.

Next, in step S505, the central control unit 131 determines whether an electronic image blur correction mode (electronic image blur correction function) is turned on. If the central control unit 131 determines that the electronic image blur correction mode is turned on, the processing advances to step S506. In step S506, the central control unit 131 performs control such that the image blur correction control unit 140 calculates the amplitude of the shake of the image capturing apparatus 100. Furthermore, the central control unit 131 performs control such that the video signal processing unit 138 performs segmentation and rotation processing on video and corrects the sloping of video resulting from rotation in the roll direction to implement electronic image blur correction.

On the other hand, if, in step S505, the central control unit 131 determines that the electronic image blur correction mode is turned off; the central control unit 131 performs control such that the video signal processing unit 138 does not implement processing of the video signal that is based on the output of the image blur correction control unit 140.

As described above, in the present embodiment, the control unit for image blur correction, the shake detection unit, the calculation unit that calculates the drive amount of the movable unit for image blur correction from the output of the shake detection unit, the position detection unit that detects the position of the movable unit, and the driving unit for driving the movable unit in order to perform image blur correction are all disposed in the fixed unit. Since data for image blur correction does not need to be exchanged between the fixed unit and the movable unit, it thereby becomes possible to suppress a drop in the performance of image blur correction, even in the case where data transmission between the movable unit and the fixed unit is performed wirelessly.

### Second Embodiment

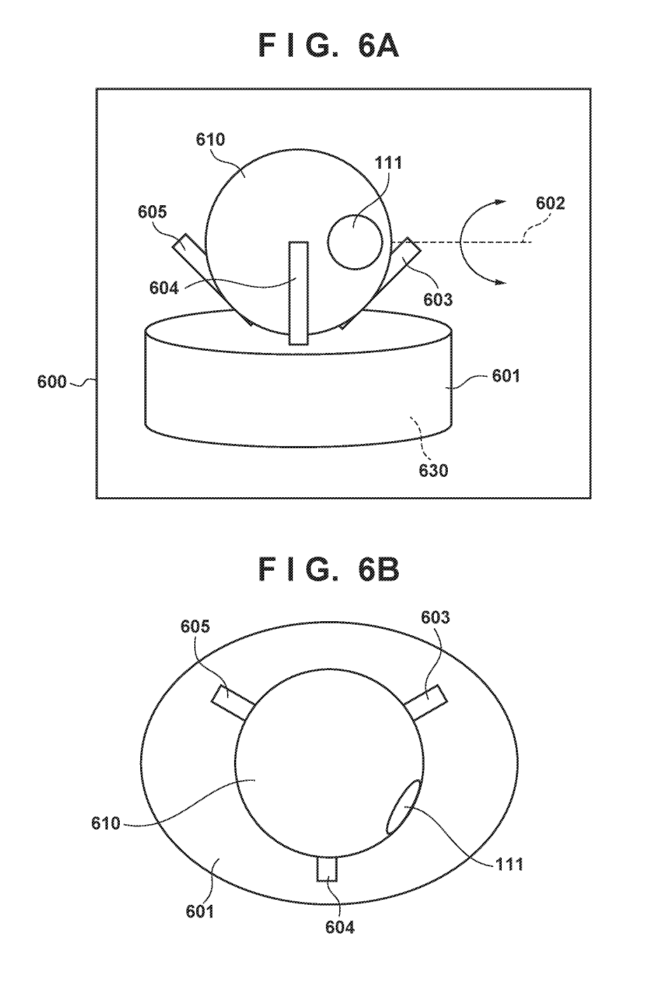

Next, FIGS. 6A and 6B are illustrative diagrams of a spherical mechanism for changing the image capturing direction in an image capturing apparatus 600 of a second embodiment of the present invention. Note that since the basic configuration of the image capturing apparatus in the present embodiment is similar to the first embodiment, the same reference signs are given to common portions, and description thereof is omitted.

FIG. 6A is a side view of the image capturing apparatus 600. A movable unit 610 is constituted by a sphere, and a bottom case 601 is constituted to include supports 603, 604 and 605 that support the spherical movable unit 610. A fixed unit 630 is disposed inside the bottom case 601, and does not move even when the movable unit 610 operates. Also, rotation about a lens optical axis 602 of the movable unit 610 is called roll direction rotation.

FIG. 6B is a plan view of the image capturing apparatus 600, with the movable unit 610 having the spherical structure being supported with the supports 603, 604 and 605 disposed at a regular interval of 120 degrees. A vibration actuator is installed in each of the supports 603, 604 and 605, and it is possible to drive the movable unit 610 in a desired direction to a desired angle of rotation. That is, it is possible to freely change the orientation of the lens unit 111 of the movable unit 610.

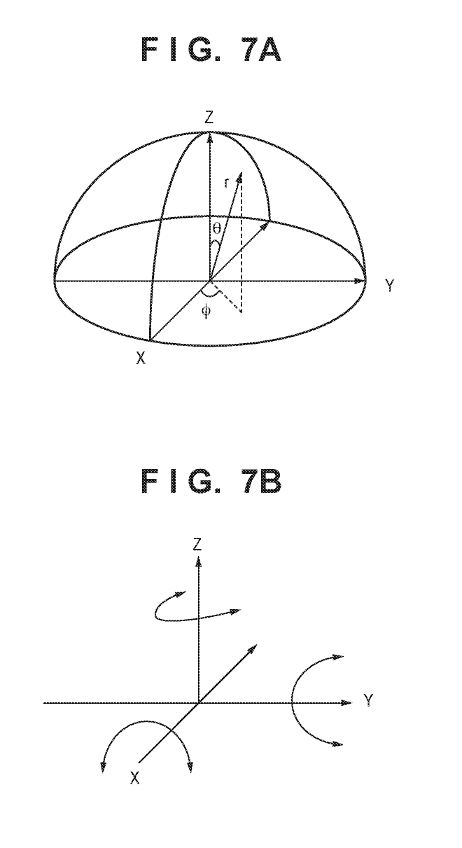

FIG. 7A is a diagram showing a spherical coordinate system for describing the orientation (camera orientation direction) of the movable unit 610 relative to the bottom case 601. A spherical coordinate system is a polar coordinate system represented with one radial coordinate and two angular coordinates. A first angle is an angle that is formed by a certain axis and the moving radius, and a second angle is an angle that is formed by another axis in a plane perpendicular to that certain axis and the projection of the moving radius on that plane. Normally, radial coordinate is represented using the symbol r, the first angular coordinate is represented using θ, and the second angular coordinate is represented using φ.

FIG. 7B is an illustrative diagram regarding shake detection axes of the shake detection unit 139. The shake detection unit 139 is disposed inside the bottom case 601, and is constituted to include angular velocity sensors that detect the angular velocity around an X-axis, a Y-axis and a Z-axis that are orthogonal to each other.

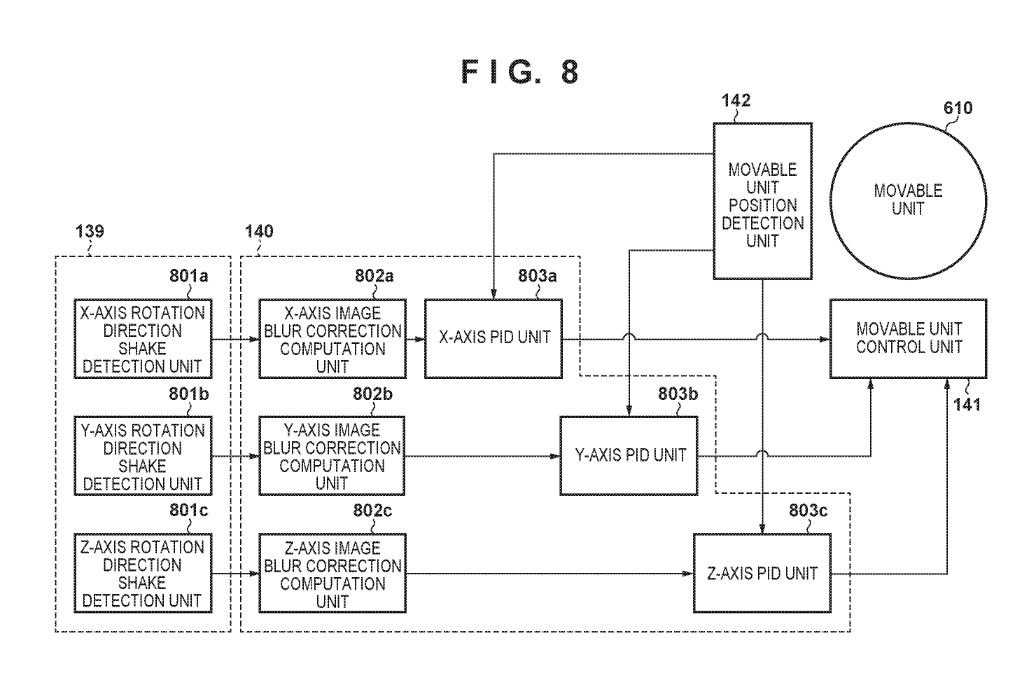

Next, a method of correcting image blur caused by shake of the image capturing apparatus 600 will be described, with reference to FIG. 8. FIG. 8 is a block diagram showing the configuration of the shake detection unit 139, the image blur correction control unit 140, the movable unit control unit 141 and the movable unit position detection unit 142.

The shake detection unit 139 is provided with an X-axis rotation direction shake detection unit 801a, a Y-axis rotation direction shake detection unit 801b and a Z-axis rotation direction shake detection unit 801c shown in FIG. 7B, as shake detection units that detect shake that is applied to the image capturing apparatus 600. Shake in the horizontal direction (pan direction) of the image capturing apparatus 600 in a normal attitude, shake in the vertical direction (tilt direction) of the image capturing apparatus 600 in a normal attitude, and shake in the rotation direction (roll direction) about the lens optical axis 602 of the movable unit 610 are detected, and shake signals are output. Note that the normal attitude represents an attitude in which the longitudinal direction of an image frame substantially coincides with the horizontal direction.

The image blur correction control unit 140 is constituted to include an X-axis image blur correction computation unit 802a, an X-axis PID unit 803a, a Y-axis image blur correction computation unit 802b, a Y-axis PID unit 803b, a Z-axis image blur correction computation unit 802c and a Z-axis PID unit 803c. The X-axis image blur correction computation unit 802a calculates a drive control signal of the movable unit 610 around the X-axis, based on the shake signal output by the X-axis rotation direction shake detection unit 801a. Similarly, the Y-axis image blur correction computation unit 802b calculates a drive control signal of the movable unit 610 around the Y-axis, based on the shake signal output by the Y-axis rotation direction shake detection unit 801b. Similarly, the Z-axis image blur correction computation unit 802c calculates a drive control signal of the movable unit 610 around the Z-axis, based on the shake signal output by the Z-axis rotation direction shake detection unit 801c.

The movable unit position detection unit 142 is a position detection unit for detecting the orientation of the movable unit 610, and functions to capture the surface of the movable unit 610 using an image sensor, for example, and measure the amount of rotational movement of the movable unit 610 from the amount of movement of a feature point that is represented by image processing. The orientation of the movable unit 610 detected by the movable unit position detection unit 142 can be represented by spherical coordinates as shown in FIG. 7A.

The X-axis PID unit 803a, the Y-axis PID unit 803b and the Z-axis PID unit 803c each have a proportional control unit that performs proportional control, an integral control unit that performs integral control, and a derivative control unit that performs derivative control. As a result of such a configuration, control signals of the movable unit 610 output by the X-axis image blur correction computation unit 802a, the Y-axis image blur correction computation unit 802b and the Z-axis image blur correction computation unit 802c are respectively input to the X-axis PID unit 803a, the Y-axis PID unit 803b, and the Z-axis PID unit 803c. The X-axis PID unit 803a, the Y-axis PID unit 803b and the Z-axis PID unit 803c each calculate a control amount based on the deviation with the position signal of the movable unit position detection unit 142, and output a drive command signal.

The movable unit control unit 141 is constituted by vibration actuators respectively disposed in the supports 603, 604 and 605. The movable unit control unit 141 drives the orientation of the movable unit 610 in the pan, tilt and roll directions, based on the drive command signals (drive control signals) output by the X-axis PID unit 803a, the Y-axis PID unit 803b and the Z-axis PID unit 803c.

In this way, the X-axis PID unit 803a performs feedback control, such that the position signal output by the movable unit position detection unit 142 converges to the control signal of the movable unit output by the X-axis image blur correction computation unit 802a. Similarly, the Y-axis PID unit 803b performs feedback control, such that the position signal output by the movable unit position detection unit 142 converges to the control signal of the movable unit output by the Y-axis image blur correction computation unit 802b. Similarly, the Z-axis PID unit 803c performs feedback control, such that the position signal output by the movable unit position detection unit 142 converges to the control signal of the movable unit output by the Z-axis image blur correction computation unit 802c.

In this way, image blur can be reduced even in the case where vibration such as camera shake occurs in the image capturing apparatus 600, by driving the movable unit 610 in directions (pan direction and tilt direction) orthogonal to the optical axis and in the rotation direction around the optical axis.

Next, a method of electronically correcting image blur caused by shake of the image capturing apparatus 600 will be described.

The movable unit control unit 141 is constituted to include a vibration actuator disposed in each of the supports 603, 604 and 605. Also, drive in the roll direction is determined, based on the drive command signals (drive control signals) output by the X-axis PID unit 803a, the Y-axis PID unit 803b and the Z-axis PID unit 803c. At this time, if the roll drive range is restricted by the movable unit control unit 141 in cases such as where the drive amount in the roll direction is large, it may not be possible to correct image blur with the roll drive by the movable unit control unit 141 and residual blur may occur. With regard to the angle of rotation at which this residual blur occurs, the video signal processing unit 138 implements electronic correction (image blur correction control) to perform segmentation and rotation processing on video and correct the sloping of video resulting from rotation in the roll direction.

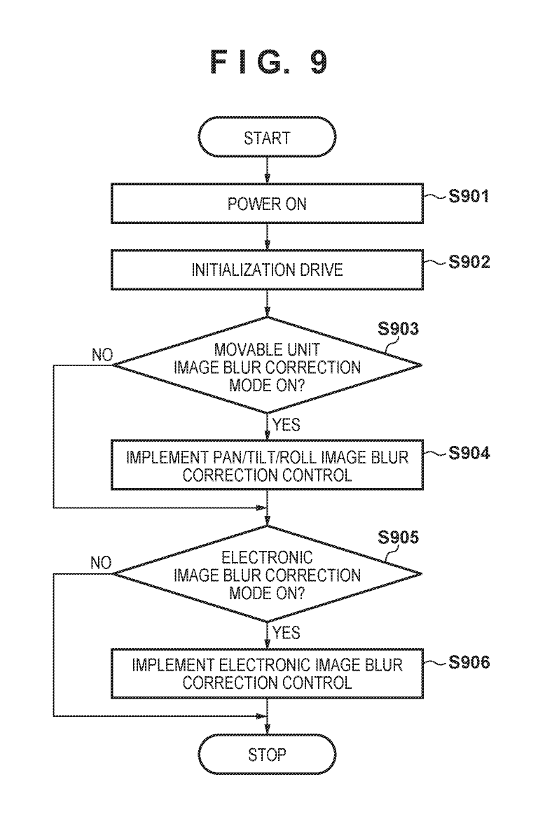

Next, image capturing operations including the image blur correction operation of the present embodiment will be described, with reference to FIG. 9. FIG. 9 is a flowchart showing image capturing operations. The steps of FIG. 9 are mainly executed based on commands from the central control unit 131 of the image capturing apparatus 600.

First, when the image capturing apparatus 600 is powered on by the user in step S901, the central control unit 131, in step S902, performs control such that the movable unit control unit 141 performs an initialization operation for driving the movable unit 610 to a predetermined initial position and fixing the movable unit 610 at the initial position.

Next, in step S903, the central control unit 131 determines whether the movable unit image blur correction mode (movable unit image blur correction function) is turned on. If the central control unit 131 determines that the movable unit image blur correction mode is turned on, the processing advances to step S904. In step S904, the central control unit 131 performs control such that the image blur correction control unit 140 performs an image blur correction operation for calculating the amplitude of the shake (vibration) of the image capturing apparatus 600 and driving the movable unit 610 in the pan direction, the tilt direction and the roll direction according to the calculated amplitude. Here, the image blur correction operation is performed by interrupt processing that occurs in a regular cycle (e.g., every 250 μsec). Also, in the present embodiment, control in each in the pan direction (transverse direction), the tilt direction (longitudinal direction), and the roll direction (rotation direction) is performed.

On the other hand, in step S903, if the central control unit 131 determines that the movable unit image blur correction mode is turned off, the central control unit 131 performs control to maintain the state in which the movable unit 610 is fixed at the initialization operation position.

Next, in step S905, the central control unit 131 determines whether the electronic image blur correction mode (electronic image blur correction function) is turned on. If the central control unit 131 determines that the electronic image blur correction mode is turned on, the processing advances to step S906. In step S906, the central control unit 131 performs control such that the image blur correction control unit 140 calculates the amplitude of the shake of the image capturing apparatus 600. Furthermore, the central control unit 131 performs control such that the video signal processing unit 138 performs segmentation and rotation processing on video and corrects the sloping of video resulting from rotation in the roll direction to implement electronic image blur correction. Also, if, in step S904, an image blur correction operation driving in the roll direction is implemented, segmentation and rotation processing of video is performed on rotation in the roll direction in which residual correction occurred in step S904. In this way, electronic image blur correction is implemented so as to correct the sloping of video resulting from rotation in the roll direction.

On the other hand, if, in step S905, the central control unit 131 determines that the electronic image blur correction mode is turned off, the central control unit 131 performs control such that the video signal processing unit 138 does not implement processing of the video signal that is based on the output of the image blur correction control unit 140.

As described above, in the present embodiment, the control unit for image blur correction, the shake detection unit, the calculation unit that calculates the drive amount of the movable unit for image blur correction from the output of the shake detection unit, the position detection unit that detects the position of the movable unit, and the driving unit for driving the movable unit in order to perform image blur correction are also all disposed in the fixed unit. Since data for image blur correction does not need to be exchanged between the fixed unit and the movable unit, it thereby becomes possible to suppress a drop in the performance of image blur correction, even in the case where data transmission between the movable unit and the fixed unit is performed wirelessly.

### Third Embodiment

The above first and second embodiments explained that as a result of the control unit for image blur correction, the shake detection unit, the calculation unit that calculates the drive amount of the movable unit for image blur correction from the output of the shake detection unit, the position detection unit that detects the position of the movable unit, and the driving unit for driving the movable unit in order to perform image blur correction all being disposed in the fixed unit, it becomes possible to suppress a drop in the performance of image blur correction, even in the case where data transmission between the movable unit and the fixed unit is performed wirelessly.

However, in actuality, image capture data is also transmitted wirelessly. Thus, in the case where wireless communication conditions deteriorate and the movable unit is not able to send image capture data to the fixed unit at the correct timing, a shift occurs in the correspondence between the correction data for electronic image blur correction and the image capture data. It may thereby not be possible to perform electronic image blur correction correctly.

In view of this, in the present embodiment, a configuration is adopted in which the correction data for electronic image blur correction that is acquired sequentially is stored, and the stored correction data is allocated to image capture data that is sent from the movable unit. It thereby becomes possible to effectively perform correction operations employing electronic image blur correction, even in the case where the movable unit is not able to send image capture data correctly. Hereinafter, this configuration will be specifically described. Note that since many of the portions in the configuration of the image capturing apparatus of this third embodiment are common to the configuration of the image capturing apparatus of the first embodiment, the same reference signs are given to portions that are the same, and description thereof is omitted.

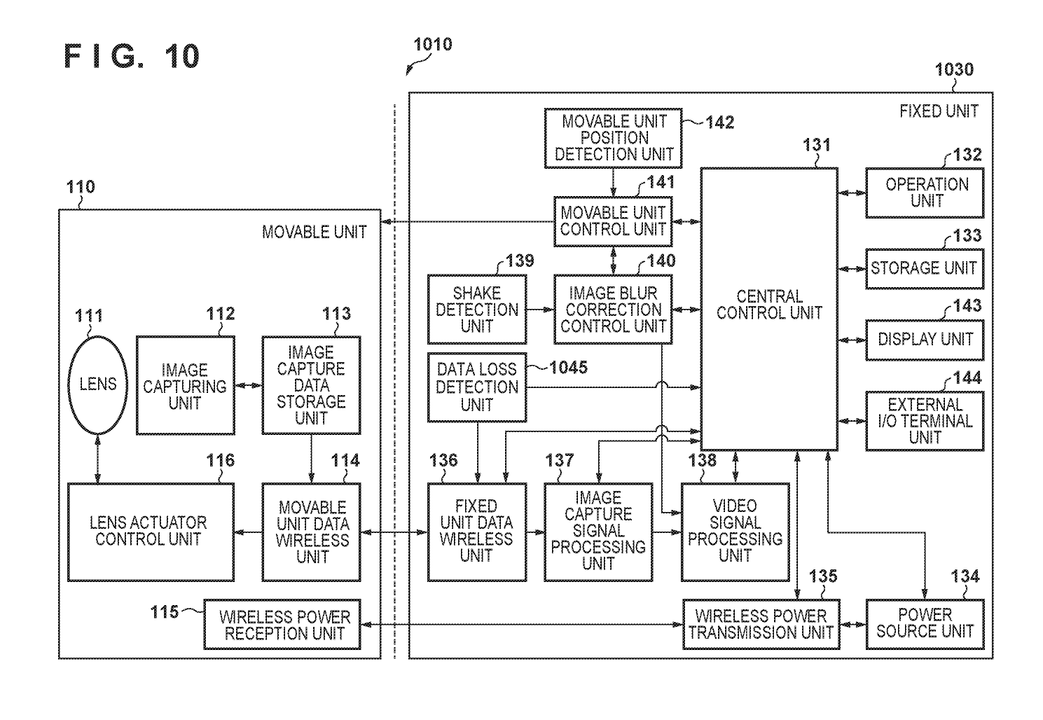

FIG. 10 is a block diagram showing the configuration of the image capturing apparatus according to the third embodiment of the present invention. In FIG. 10, the image capturing apparatus 1010 is constituted to include a movable unit 110 including a lens unit and a fixed unit 1030 including a central control unit (CPU) that performs drive control of the movable unit 110 and control of the entirety of the image capturing apparatus.

In FIG. 10, the external configuration of the movable unit 110 is similar to the first embodiment. The movable unit 110 differs from the first embodiment in the operation of the movable unit data wireless unit 114. The movable unit data wireless unit 114 includes a transmitting and receiving antenna, and implements data communication between the movable unit 110 and the fixed unit 1030 by wireless communication. Here, when transmitting output data from the image capturing unit 112 to the fixed unit 1030 by wireless communication, the output data is transmitted in chronological order of the image capture data stored in the image capture data storage unit 113. Also, the movable unit data wireless unit 114, when sending image capture data to the fixed unit 1030, also transmits chronological sequence numbers of the stored image capture data. The sequence numbers may be transferred by including the order in which the image capture data was captured by the image capturing unit 112 in the header of the image capture data, for example. Also, every time the image capture data storage unit 113 stores image capture data may be counted, and the count number may be used as the sequence number.

Also, in FIG. 10, the fixed unit 1030 differs from the first embodiment in having a data loss detection unit 1045. The data loss detection unit 1045 checks whether there is any data loss in the image capture data that is sent from the movable unit data wireless unit 114 to the fixed unit data wireless unit 136. For example, the data loss detection unit 1045 extracts the chronological sequence number of image capture data from the data sent from the movable unit data wireless unit 114, and judges that data loss has occurred in the image capture data in the case where the sequence numbers are discontinuous.

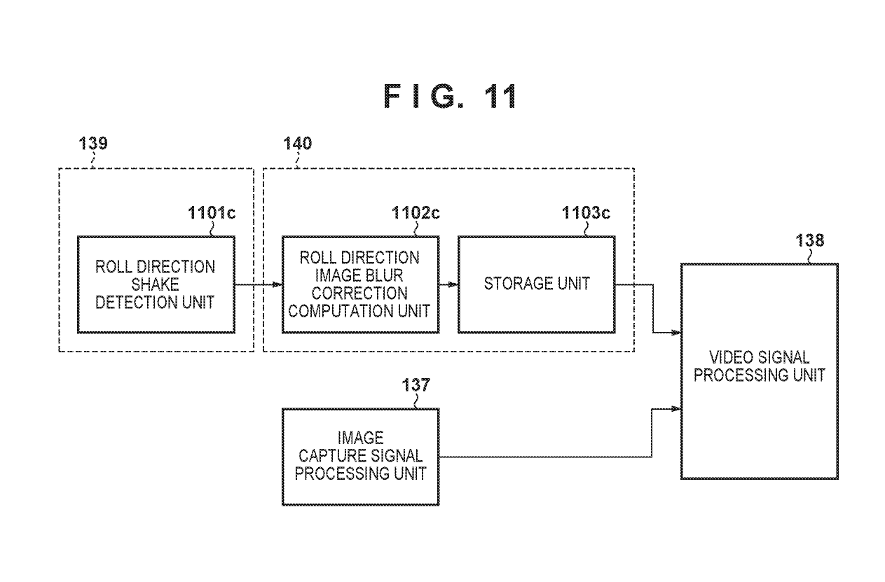

Next, a method of electronically correcting image blur due to shake of the image capturing apparatus 1010 will be described, with reference to FIG. 11. FIG. 11 is a block diagram showing the configuration of the shake detection unit 139, the image blur correction control unit 140, the image capture signal processing unit 137, and the video signal processing unit 138.

The shake detection unit 139 is provided with a roll direction shake detection unit 1101c that detects shake (vibration) in the roll direction that is applied to the image capturing apparatus 1010. The roll direction shake detection unit 1101c is constituted to include an angular velocity sensor or a velocity sensor, for example. The roll direction shake detection unit 1101c detects shake in the rotation direction (roll direction) around the optical axis of the image capturing apparatus 1010 in a normal attitude (attitude in which the longitudinal direction of an image frame substantially coincides with the horizontal direction), and outputs a shake signal.

The image blur correction control unit 140 is constituted to include a roll direction image blur correction computation unit 1102c and a storage unit 1103c. The roll direction image blur correction computation unit 1102c, based on the shake signal output by the roll direction shake detection unit 1101c, calculates the angle of rotation in the roll direction, and calculates a control signal for rotation in the roll direction. The storage unit 1103c stores the rotation control signal output by the roll direction image blur correction computation unit 1102c.

The image capture signal processing unit 137 converts the electrical signal of the image capturing unit 112 output by the fixed unit data wireless unit 136 into a video signal. The video signal processing unit 138 performs segmentation and rotation processing on the video signal output by the image capture signal processing unit 137, based on the control signal for rotation in the roll direction stored by the storage unit 1103c. Electronic correction is thereby performed to correct the sloping of video resulting from rotation in the roll direction.

Here, when outputting rotation control signals to the video signal processing unit 138, the rotation control signals are transmitted in chronological order of the rotation control signals stored in the storage unit 1103c. Rotation control signals output to the video signal processing unit 138 may be discarded from the storage unit 1103c. In this way, image blur can be reduced, even in the case where vibration such as camera shake in the rotation direction (roll direction) around the optical axis occurs in the image capturing apparatus 1010.

Since the operations of the image capturing apparatus 1010 of the present embodiment constituted as described above are similar to the operation of the first embodiment shown in FIG. 5, description thereof is omitted.

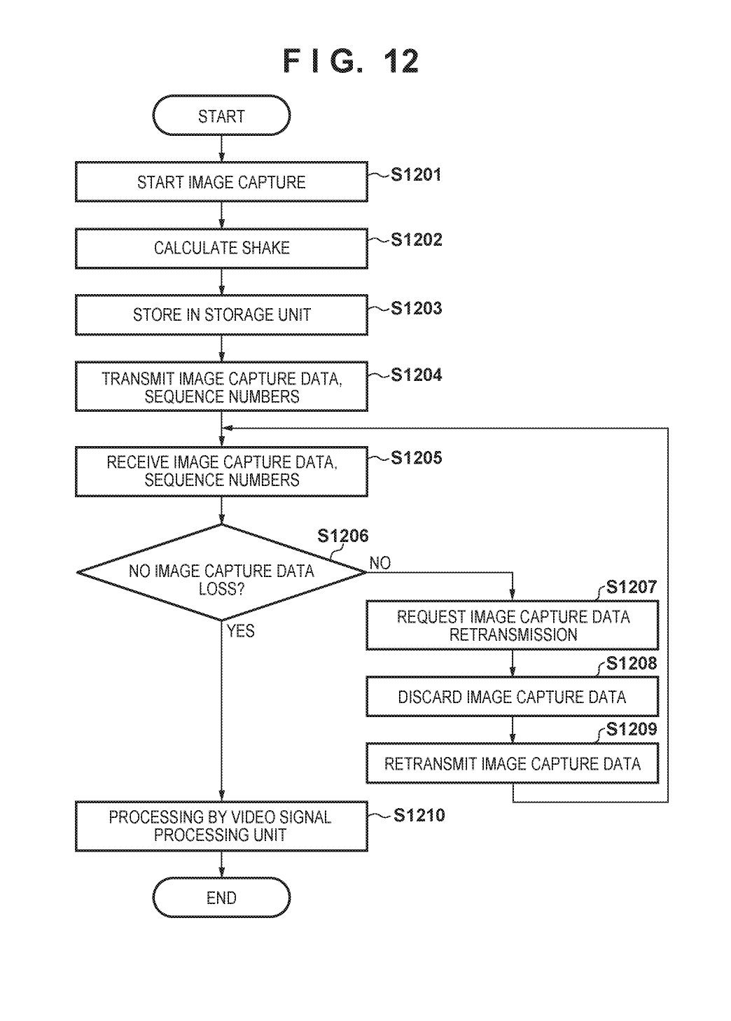

Next, image capturing operations including electronic image blur correction in the case where the wireless communication conditions between the movable unit 110 and the fixed unit 1030 deteriorate and the movable unit is not able to correctly send image capture data to the fixed unit will be described, with reference to FIG. 12. Here, it is assumed that the electronic image blur correction mode described in FIG. 5 is on and the movable unit image blur correction mode is off. The steps of FIG. 12 are mainly executed based on commands from the central control unit 131 of the image capturing apparatus 1010.

First, in step S1201, the central control unit 131 performs control such that the image capturing unit 112 starts image capture. In step S1202, the central control unit 131 performs control such that the roll direction image blur correction computation unit 1102c calculates the amplitude of the shake of the image capturing apparatus 1010, based on the shake signal output by the roll direction shake detection unit 1101c. In step S1203, the central control unit 131 performs control such that the storage unit 1103c stores the rotation control signal output by the roll direction image blur correction computation unit 1102c.

Next, in step S1204, the central control unit 131 performs control such that the movable unit data wireless unit 114 starts transmission of image capture data stored in the image capture data storage unit 113 and chronological sequence numbers of the image capture data to the fixed unit data wireless unit 136.

In step S1205, the central control unit 131 performs control such that the fixed unit data wireless unit 136 receives the image capture data and the chronological sequence numbers of image capture data from the movable unit data wireless unit 114.

In step S1206, the central control unit 131, using the data loss detection unit 1045, determines whether there is data loss in the image capture data from the chronological sequence numbers of the image capture data received by the fixed unit data wireless unit 136. If the central control unit 131 determines that the sequence numbers are discontinuous and there is data loss in the image capture data, the processing advances to step S1207.

In step S1207, the central control unit 131 performs control to transmit a retransmission request for lost image capture data and a retransmission request for lost sequence numbers to the movable unit data wireless unit 114, via the fixed unit data wireless unit 136.

In step S1208, the central control unit 131 performs control to discard image capture data having sequence numbers subsequent to the lost image capture data sent from the movable unit data wireless unit 114. In step S1209, the central control unit 131 performs control such that the movable unit data wireless unit 114, having received the retransmission request for image capture data, starts retransmission of image capture data in order from the lost sequence number.

On the other hand, if, in step S1206, the central control unit 131 determines that the sequence numbers are not discontinuous and that there is no lost image capture data, the processing advances to step S1210. In step S1210, the central control unit 131 performs control such that the video signal processing unit 138 performs segmentation and rotation processing on the video signal output by the image capture signal processing unit 137, based on the control signal for rotation in the roll direction stored by the storage unit 1103c.

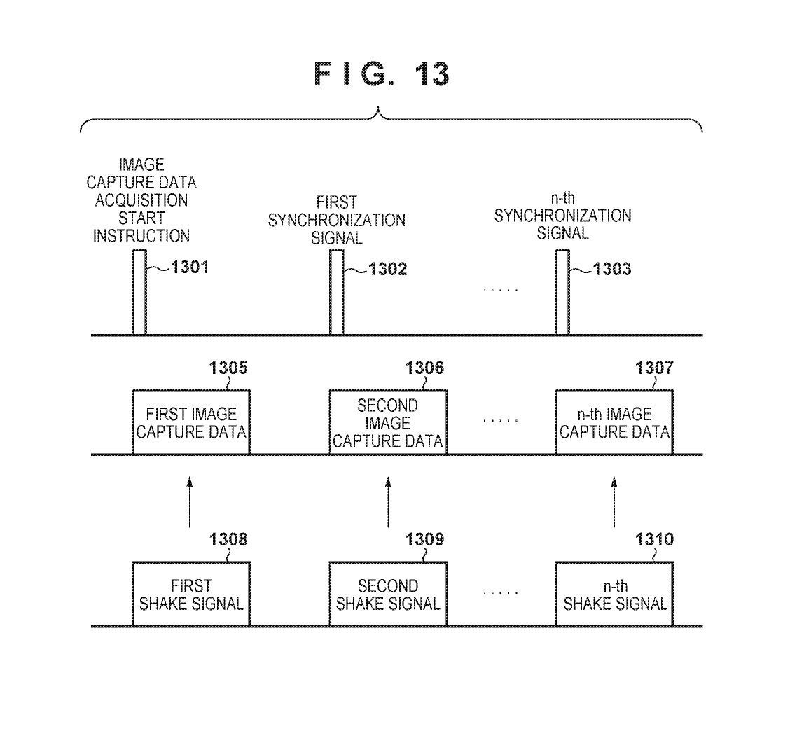

In step S1210, the shake signals from which are derived the rotation control signals stored in the storage unit 1103c in order to perform segmentation and rotation processing need to be shake signals acquired when the image capture data from which is derived the video signals output by the image capture signal processing unit 137 was acquired. Here, an example of the acquisition timing of the image capture data that is acquired by the image capturing unit 112 and the shake signal that is acquired by the roll direction shake detection unit 1101c will be described, with reference to FIG. 13.

FIG. 13 is a diagram showing shake signals acquired by the roll direction shake detection unit 1101c in synchronization with the acquisition timing of image capture data for each frame that is acquired by the image capturing unit 112, and acquired shake signals associated with respective image capture data.

An image capture data acquisition start instruction 1301 is a signal for causing the image capturing unit 112 to start image capture. The image capturing unit 112 starts image capture with receipt of the image capture data acquisition start instruction 1301. That is, the image capturing unit 112 starts exposure, and starts readout after performing exposure for a predetermined period of time.

A first synchronization signal 1302 and an n-th synchronization signal 1303 are similarly transmitted from the central control unit 131 to the image capturing unit 112, and control the timing at which the image capturing unit 112 starts receiving light. First image capture data 1305 is image capture data that is acquired by the image capturing unit 112, and is acquired in the image capturing unit 112 along with the image capture data acquisition start instruction 1301 that is transmitted from the central control unit 131. Second image capture data 1306 is acquired in the image capturing unit 112 in time with the first synchronization signal 1302, after the image capture data acquisition start instruction 1301. Also, n-th image capture data 1307 is acquired in the image capturing unit 112 in time with the n-th synchronization signal 1303, after the image capture data acquisition start instruction 1302.

Also, a first shake signal 1308, a second shake signal 1309 and an n-th shake signal 1310 are shake signals that are acquired by the roll direction shake detection unit 1101c. The roll direction shake detection unit 1101c acquires the first shake signal 1308 along with the image capture data acquisition start instruction 1301 that is transmitted from the central control unit 131. Adopting this configuration enables the first shake signal 1308 to be acquired in synchronization with the acquisition timing of the first image capture data 1305. Also, the first shake signal 1308 can be associated with the first image capture data 1305, by storing the shake signal in association with the image capture data acquisition start instruction 1301.

The roll direction shake detection unit 1101c similarly acquires the second shake signal 1309 and the n-th shake signal 1310 along with the first synchronization signal 1302 and the n-th synchronization signal 1303 generated by the central control unit 131. Adopting this configuration enables the second shake signal 1309 and the n-th shake signal 1310 to be acquired in synchronization with the acquisition timing of the second image capture data 1306 and the n-th image capture data 1307. Also, the second shake signal 1309 can be associated with the second image capture data 1306 and the n-th shake signal 1310 can be associated with the n-th image capture data 1307, by storing the shake signals in association with respective synchronization signals.

In the flowchart of FIG. 12, if, in step S1209, the n-th image capture data 1307 is resent, the n-th shake signal 1310 is associated with the n-th image capture data 1307. Thus, processing can be performed with the correct combination in the video signal processing unit 138.

In this way, even if the wireless communication conditions between the movable unit 110 and the fixed unit 1030 deteriorate and image capture data cannot be correctly sent from the movable unit to the fixed unit, image blur can be reduced by using the electronic image blur correction operation.

In the present embodiment, if there is lost image capture data, image capture data having sequence numbers subsequent to the lost image capture data is discarded in step S1208, but the present invention is not limited thereto.

For example, a method may be adopted in which image capture data having sequence numbers subsequent to lost image capture data is stored in the storage unit 133. Then, in step S1209, the movable unit is made to retransmit only the lost image capture data, and the video signal processing unit 138 preferentially performs processing on the retransmitted image capture data. After processing of the retransmitted image capture data has ended, the image capture data stored in the storage unit 133 is processed in the order of the sequence numbers.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-211207, filed Oct. 31, 2017, which is hereby incorporated by reference herein in its entirety.

What is claimed is:

1. An image capturing apparatus comprising:
a movable unit configured to perform image capture; and
a supporting unit configured to support the movable unit,
wherein the movable unit includes:
an image capturing unit configured to capture an object, and
the supporting unit includes:
a driving unit configured to drive so as to change an orientation of the movable unit;
a position detection unit configured to detect a position of the movable unit;
a shake detection unit configured to detect shake of the image capturing apparatus;
a determination unit configured to determine a driving target position of the driving unit, based on the shake detected by the shake detection unit; and
a control unit configured to control the driving unit such that the position of the movable unit detected by the position detection unit converges to the driving target position determined by the determination unit.

2. The image capturing apparatus according to claim 1,
wherein the movable unit further includes:
a transmission unit configured to wirelessly transmit at least image capture data obtained by the image capturing unit to the supporting unit, and
the supporting unit further includes:
a reception unit configured to receive a signal transmitted from the transmission unit.

3. The image capturing apparatus according to claim 1,
wherein the movable unit further includes:
a power reception unit configured to receive supply of power wirelessly from the supporting unit, and
the supporting unit further includes:
a power transmission unit configured to supply power wirelessly to the movable unit.

4. The image capturing apparatus according to claim 1,
wherein the supporting unit further includes:
a signal processing unit configured to perform signal processing on image capture data obtained by the image capturing unit, based on the shake detected by the shake detection unit.

5. The image capturing apparatus according to claim 4,
wherein the signal processing unit corrects blur of the image capture data around an optical axis, by segmenting an image from the image capture data and rotating the segmented image.

6. The image capturing apparatus according to claim 1,
wherein the movable unit further includes:
a first storage unit configured to store image capture data obtained by the image capturing unit in captured order, and
the movable unit reads out the image capture data from the first storage unit, and transmits to the supporting unit the read image capture data in captured order.

7. The image capturing apparatus according to claim 6,
wherein the first storage unit further stores information on an order in which the image capture data is obtained by the image capturing unit, and
the movable unit transmits the order information to the supporting unit together with the image capture data.

8. The image capturing apparatus according to claim 7,
wherein the supporting unit further includes:
a second storage unit configured to store the order information received from the movable unit.

9. The image capturing apparatus according to claim 7,
wherein the supporting unit further includes:
a determination unit configured to determine whether there is data loss in the image capture data received from the movable unit, based on the order information.

10. The image capturing apparatus according to claim 9,
wherein, the supporting unit, in a case where it is determined by the determination unit that there is data loss in the image capture data, causes the movable unit to resend the lost image capture data.

11. The image capturing apparatus according to claim 1,
wherein the driving unit rotationally drives the movable unit around a plurality of axes.

12. The image capturing apparatus according to claim 11,
therein the driving unit drives the movable unit in a pan direction and a tilt direction of the image capturing unit.

13. The image capturing apparatus according to claim 11,
wherein the movable unit is a sphere, and
the driving unit applies vibration to a surface of the sphere to rotate the sphere.

14. A supporting apparatus that supports a movable unit including an image capturing unit configured to capture an object, comprising:
a driving unit configured to drive so as to change an orientation of the movable unit;
a position detection unit configured to detect a position of the movable unit;
a shake detection unit configured to detect shake of the supporting apparatus;
a determination unit configured to determine a driving target position of the driving unit, based on the shake detected by the shake detection unit; and
a control unit configured to control the driving unit such that the position of the movable unit detected by the position detection unit converges to the driving target position determined by the determination unit.

15. A control method for an image capturing apparatus including a movable unit having an image capturing unit configured to capture an object and a supporting unit configured to support the movable unit, the method comprising:
driving so as to change an orientation of the movable unit;
detecting a position of the movable unit;
detecting shake of the image capturing apparatus;
determining a driving target position in the driving, based on the shake detected in the shake detection; and
controlling the driving such that the position of the movable unit detected in the position detection converges to the driving target position determined in the determination.

16. A control method for a supporting apparatus configured to support a movable unit including an image capturing unit configured to capture an object, the control method comprising:
driving so as to change an orientation of the movable unit;
detecting a position of the movable unit;
detecting shake of the image capturing apparatus;
determining a driving target position in the driving, based on the shake detected in the shake detection; and
controlling the driving such that the position of the movable unit detected in the position detection converges to the driving target position determined in the determination.
